(19) United States
(12) Patent Application Publication
(10) Pub. No.: US 2003/0221309 A1
(43) Pub. Date: Dec. 4, 2003

(54) Modular dice system for slider bar parting

(75) Inventors: Douglas Hampton Cole, Golden Valley, MN (US); Gordon Merle Jones, Eagan, MN (US)

Correspondence Address: MERCHANT & GOULD PC, P.O. BOX 2903, MINNEAPOLIS, MN, 55402-0903, US

(73) Assignee: Seagate Technology LLC, Scotts Valley, CA

(21) Appl. No.: 10/449,657

(22) Filed: May 29, 2003

Related U.S. Application Data
(60) Provisional application No. 60/384,520, filed on May 29, 2002.

(51) Int. Cl. G11B 5/127

(52) U.S. Cl. 29/603.07

(57) ABSTRACT

The present invention relates to a dice system that is configured to manufacture disc drive heads from a substrate. The dice system includes a first dicing station that includes a plurality of processing modules. The dice system also includes a control module separate and distinct from the first dicing station. The control module is adapted and configured to control functions of the first dicing station modules and is further capable of being positioned at a remote location from the first dicing station.

### RELATED APPLICATIONS

This application claims priority of U.S. provisional application Serial No. 60/384,520, filed May 29, 2002.

### TECHNICAL FIELD

This application generally relates to automated manufacturing and manufacturing control systems, and more particularly, this application relates to the disc drive head manufacturing utilizing dice machines.

### BACKGROUND

In the field of semiconductor and disc drive manufacturing, it is frequently necessary to separate a monolithic ceramic or silicon wafer, upon which many individual chip dies or disc drive heads are patterned, into their several component parts. Generally, in the case of disc drive head manufacture, a round or square ceramic substrate wafer is patterned with tens of thousands of individual disc drive slider heads using thin film microelectronic techniques. These heads must first be separated into manageable strips, called “row bars,” for processing. Following many process steps, the row bars are then singulated into individual disc drive heads. The process of parting a ceramic wafer into long strips of connected disc drive heads is known as “slicing.” The individual singulation of slider heads from that row bar is known as “dicing.” The equipment used to perform the dicing operation is known as a “dicer” (also referred to herein as a dice tool or a dice machine or dice station).

In the field of disc drive head manufacturing, many current dice machines use single row (i.e., one blade is used to cut one strip at a time) or gang tools (i.e., several blades are mounted on a common spindle, which is then referred to as a wheel gang, and used to cut multiple strips simultaneously), and integrate all process controls and mechanisms into one monolithic tool. Herein a monolithic tool refers to a stand-alone device which incorporates all necessary functions (blades, spindles, coolant delivery, computer controls, and all other components necessary to perform a dicing process). These monolithic tools are very expensive to repair, replace, or upgrade. On the other hand, some current tools implement some level of automated data input/output features, but are not designed to leverage economies of scale in data processing or machine control. Most master/slave manufacture control architectures implemented in current systems have several shortcomings. For example, since most dice systems are currently monolithic machines, these master/slave control systems needlessly duplicate data input/output functions, control codes, and consumables such as pumping and filtering of coolants.

Moreover, the current data 1/0 structures are not particularly amenable to convenient and rapid upgrade, as any upgrade must be performed on each and every dicer in all factories which use the machines, which can number in the dozens or hundreds for large fabrication plants. Such an upgrade is expensive and time consuming. As a result, many companies are forced to install a full software upgrade per tool/system, even though the upgrade is only directed at a portion of the control and processing software. Furthermore, when components fail or technological improvements for the hardware become available, the monolithic structure of many current tools require massive re-tooling throughout whole factories.

The creation of a dice tool capable of the precision necessary to conduct dicing of disc drive heads from row-bars requires a variety of different skill sets to be brought to bear by a tool manufacturer. Automation, precision cutting, vision, and cooling/pumping expertise must all reside in one vendor. Some vendors are superior at one skill set, but lacking in others, while other vendors may not include some necessary technology in their system or outsource these requirements to a separate company which may not have the capabilities demanded by the disc drive manufacturer for their particular requirements. This complex web of skill sets makes the current set of parting machines, or dice machines, an inadequate compromise of a vendor's strengths with their weaknesses, and current solutions to address those weaknesses are incompatible with the monolithic tool design offered to the disc drive manufacturer.

Accordingly, there is a need for improved manufacturing control systems and methods relating to the manufacturing of disc drive heads utilizing dice machines. The present invention provides a solution to many problems, such as those discussed above, currently faced in the industry.

### SUMMARY

The present invention provides a modular dice system and method of manufacturing that allows the outsourcing of the various stations, such as the cut, clean, and vision stations if desired, allowing state of the art technology to be installed over time without requiring factory-wide capital expenditures. The present invention also substantially eliminates data I/O, control, and consumables redundancy by preventing duplication of basic functions. Further, the present invention facilitates control of all dice tool machines from a centrally located single source, providing better control of software versions and machine states, reducing process variability and increasing control.

The present invention is generally based upon a modular load/unload feed drive train with very precisely defined mechanical, data, and consumables interfaces. According to the present invention, the disc drive row bar or array of row bars are inserted into a modular system that includes several components interacting through a specified interface. In other words, a modular system is a system that implements several of its functional components by compartmentalizing each to a particular module, which is in contrast to monolithic systems wherein all the functions are embodied in a single device. An example modular system embodiment includes a load/unload module, a feed stage module, a cutting module, a vision module, a cleaning module, and a scalable control and communications module that controls and manages the dice tool system. In another embodiment, the control and communication module controls and manages a plurality of individual dice tools.

An embodiment of the present invention incorporating all of these modular components into a modular dice system overcomes many shortcomings of known monolithic dice systems. The present invention allows the disc drive manufacturer to select the best available technology as it becomes available, so long as the new technology is designed to be compatible with the interface specifications for the other modules. By providing the necessary slider bar parting process and control functionality in a modular architecture, the present invention allows the process owner/manufacturer to develop improvements to each module that do not require the replacement of the entire system, or even to outsource improvement development as long as the interface between modules is preserved.

A further benefit of the present invention is that it allows the process owner/manufacturer to run a dice system that utilizes very different cutting technologies. For example, dice wheels or a wire saw can be substituted for each other without requiring a massive re-tool of an entire factory. Further, most other dice systems are monolithic machines that needlessly duplicate data input/output functions, control codes, and consumables. The present invention provides a system that eliminates these redundancies by isolating the command and control function to a separate module. This also provides a scalable data I/O structure, which allows for innovation in communications or data processing to be enabled without forcing one upgrade per cutting tool.

One aspect of the present invention relates to a dice system that is configured to manufacture disc drive heads from a substrate. The dice system includes a first dicing station that includes a plurality of processing modules. The dice system also includes a control module separate and distinct from the first dicing station. The control module is adapted and configured to control functions of the first dicing station modules and is further capable of being positioned at a remote location from the first dicing station.

Another aspect of the present invention relates to a method of manufacturing a disc drive head from a substrate with a dice system. The system may include a first dicing station having a plurality of processing modules, a drive train, and a control module separate and distinct from the first dicing station. The method may include the steps of moving the substrate from one processing module to another processing module of the dicing station with the drive train, and controlling functions of the plurality of processing modules of the first dicing station with the control module to form a disc drive head from the substrate.

According to a yet further aspect of the present invention, a modular dicing system includes at least one modular dicing station with a plurality of features and modules. The at least one dicing station includes a drive train, first and second load-unload modules, a cutting module, and a cleaning module. The cutting and cleaning modules may be operatively coupled to the feed drive train and the first and second load-unload modules. The dicing system may also include control means for controlling the at least one modular dicing station. The control means may be separate and distinct from the at least one modular dicing station and may be capable of being positioned at a remote location from the first dicing station.

These and various other features as well as advantages which characterize the present invention will be apparent from a reading of the following detailed description and a review of the associated drawings.

### BRIEF DESCRIPTION OF THE DRAWINGS

FIG. 1 illustrates one example of a modular dice system according to an embodiment of the present invention.

FIG. 2 illustrates another example of a modular dice system wherein several dicing stations are managed by a central control module according to another embodiment of the present invention.

FIG. 3 illustrates an example of a single dicing station based modular dice system according to one possible embodiment of the present invention.

FIG. 4 illustrates a configurational, detailed schematic of a modular dicing station according to the present invention.

FIG. 5 illustrates an embodiment of computing systems used as part of a control island according to an example embodiment of the present invention.

FIG. 6 illustrates an embodiment of computing systems used as part of a modular manufacturing processing module according to an example embodiment of the present invention.

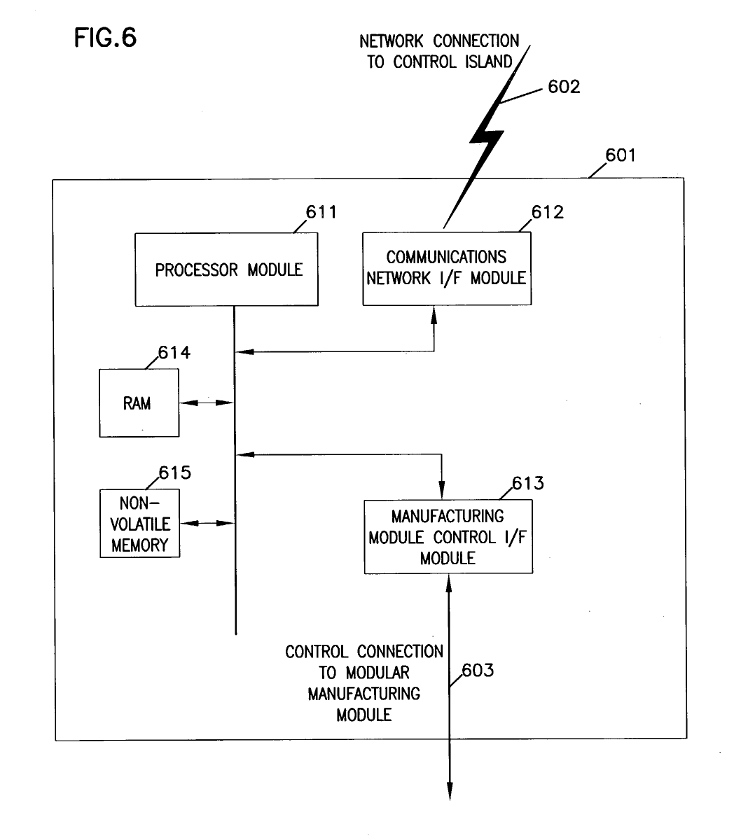

FIG. 7 illustrates a set of processing modules used as part of a control island according to an example embodiment of the present invention.

FIG. 8 illustrates a set of processing modules used as part of a modular manufacturing processing module according to an exemplary embodiment of the present invention.

FIG. 9 illustrates an operational flowchart corresponding to a modular dicing system according to one embodiment of the present invention.

### DETAILED DESCRIPTION OF THE DRAWINGS

The present invention provides a modular dice system and method of manufacturing a disc drive head. The present invention is configured with a plurality of modular stations, such as the cut, clean, and vision stations if desired, allowing state of the art technology upgrades to the system over time without having to replace the entire system. The present invention also substantially eliminates data I/O, control, and consumables redundancy by consolidating these basic functions in a central location. Further, the present invention may control multiple dice tool machines from a centrally located source, providing better control of software versions and machine states, which reduces process variability and increases control.

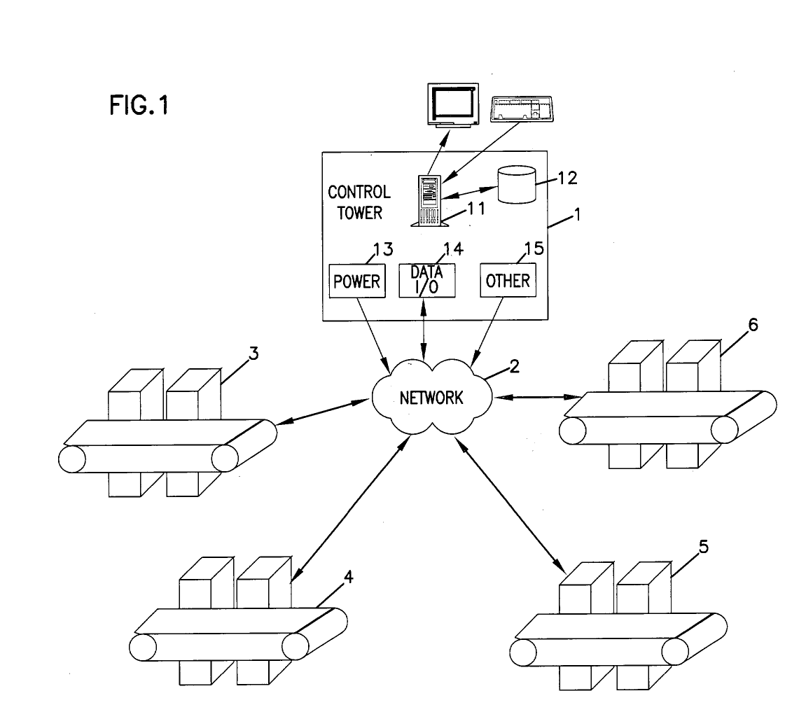

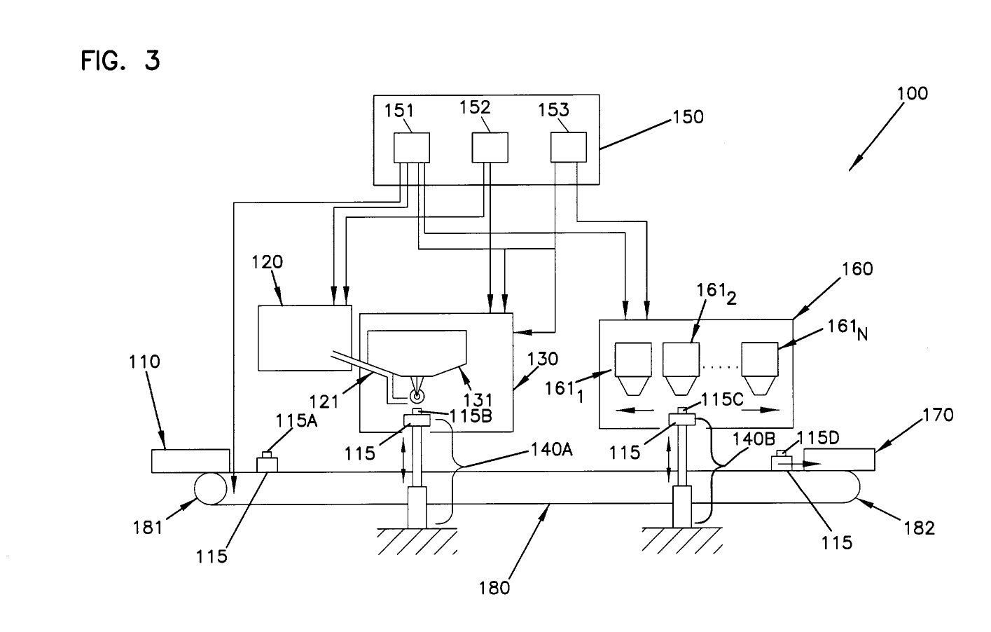

FIG. 1 illustrates one example of a modular dice system according to an embodiment of the present invention. The modular dice system includes a control island 1, a communication means or network 2, and a plurality of dicing stations 3-6. The control island 1 includes a power module 13, a data I/O module 14, and a consumable control (“other”) module 15. The control island further includes a computing system 11 communicatively coupled to a database 12. Computing system 11 may be coupled to a monitor 20 and a keyboard 22 to provide an interface for an operation of the entire modular dice system. The control island 1 controls and communicates with the dicing stations 3-6 through the communication network 2. In other words, all control signals generated by the control island 1 are transmitted over the network 2 (which may be, for example, a localized network, a wide area network, or the Internet) and are received and processed at the dicing stations 3-6. A detailed description of how one dicing station embodiment of the present invention operates and is configured within a system is provided in the discussion below with respect to FIG. 3.

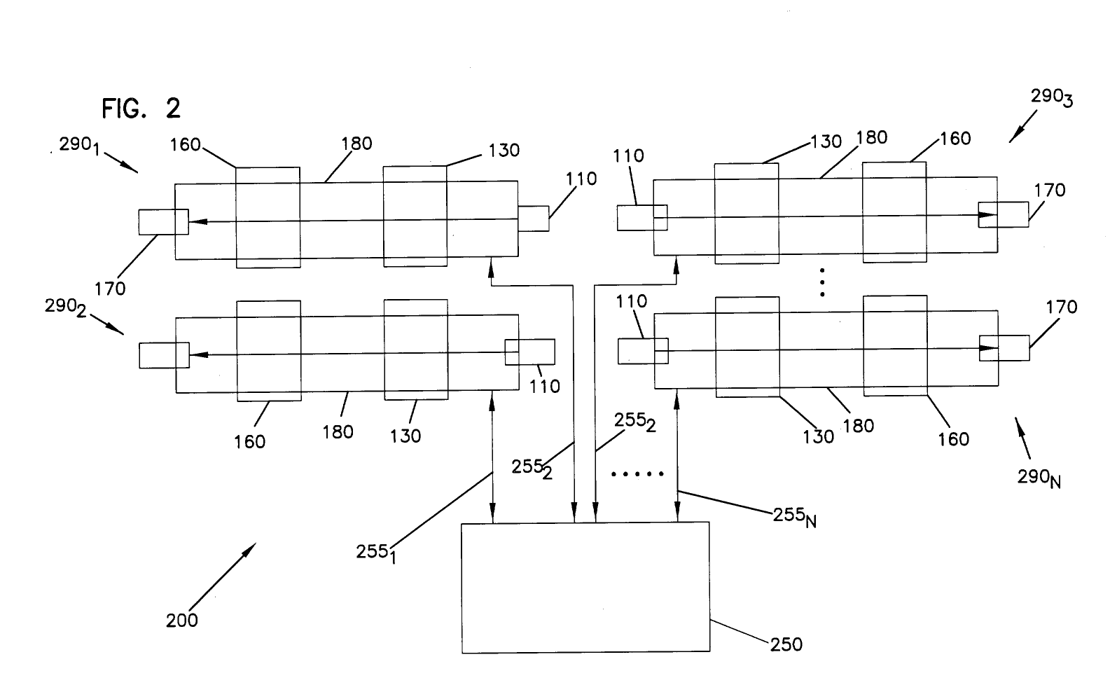

FIG. 2 illustrates a high-level schematic of an example modular dice system 200 wherein several dicing stations 290₁-290_{N} are managed by a central control island module 250. The dicing stations 290₁-290_{N} are operatively coupled to control island module 250 via a plurality of operational control channels 255₁-255_{N}. The operational control channels 255₁-255_{N} include data I/O and power transmission lines and coupling control means to transport consumable products to a desired location within a given cutting stage 290₁-290_{N}.

Each dicing station 290₁-290_{N} is configured and operates the same as a dice system 100 shown and described with reference to FIG. 3. Thus, the system 200 is similar to the system 100 shown in FIG. 3 except that the single control island 250 drives and provides the power, system control, data processing, networking, database and consumable maintenance functionality for multiple dicing stations 290₁-290_{N.}

FIG. 3 illustrates an example of a modular dice system 100 having a single dicing station. The modular dice system 100 includes a vision module 120 coupled to a cutting module 130 by a monitoring signal transmission channel 121, a first load-unload module 140A, and a second load-unload module 140B, a cleaning module 160, and a feed drive train 180. The modular dice system 100 further includes a control module or control island 150.

The modular dice system 100 further includes a part carrier 115 supported by the feed drive train 180 and configured to carry a row bar through the system 100. FIG. 3 illustrates an undiced row bar 115A and a row bar 115B being cut into a plurality of row bar elements in the cutting module 130, a plurality of row bar elements 115C being cleaned in the cleaning module 160, and a plurality of cut and cleaned row bar elements 115D. The cutting module 130 includes a cut stage device 131 for dicing the undiced row bar 115A into a plurality of row bar elements. One skilled in the art can appreciate that the cut stage device 131 can be implemented with one or a combination of parting systems. In one embodiment, for example, the cut stage device 131 is implemented as a wire saw.

The control island of the present invention may include a power source, and may also include control, networking and analysis/database functions. The control island may also be configured to control consumables, such as cut coolant/slurry or cleaning solvents, used, for example, in the cutting and cleaning modules. The control island 150 includes a power module 151, a data I/O module 152, and a consumable module 153. In one embodiment of the present invention control island 150 can provide these functions for multiple cut stations (for example, see control island 250 of system 200). The cleaning module 160 may include multiple cleaning stage devices 161₁-161_{N} for cleaning the plurality of row bar elements 115C.

Operation of the modular dice system 100 may be initiated after an operator of system 100 places a stack of uncut row bars 115A into a feed magazine 110 that is positioned at a first end 181 of feed drive train 180. In some embodiments, filling and positioning of the feed magazine 110 at the first end 181 of the drive train 180 is performed by an automated process. After the magazine 110 is properly filled and positioned at the first end 181, a bar carrier 115 engages an uncut row bar 115A and the control island 150 commands the feed drive train 180 to move the carrier and the uncut row bar 115A through the system 100.

When the carrier 115 is moved into a position adjacent the load-unload module 140A, the control island 150 commands the load-unload module 140A to vertically translate the uncut row bar 115B to a cutting position adjacent the cut stage device 131 of the cutting module 130. The cut stage device 131 is then used to cut the undiced row bar 115B when the control island 150, via data I/O module 152, transmits the appropriate control signal to the cutting module 130. The vision module 120 monitors the cutting process via monitoring signal transmission channel 121, and transmits the resulting data signal to the control island 150. The control island 150 processes this data signal and provides guidance to the cut stage device 131 with appropriate control signals.

Once the uncut row bar 115B undergoes dicing at the cutting module 130, the load-unload module 140A returns the resulting plurality of row bar elements 115B to the feed drive train 180. The plurality of row bar elements 115B are translated through the system 100 until the carrier engages the second load-unload module 140B. The load-unload module 140B vertically translates the plurality of row bar elements 115C to a position in cleaning module 160 adjacent at least one cleaning stage device 161₁-161_{N}. The control island 150 then commands the at least one cleaning stage device 161₁-161_{N} to begin cleaning the plurality of row bar elements 115C. When necessary, the control island 150 controls consumable module 153 to dispense necessary consumables, such as cleaning solutions, to ensure proper functioning of the cleaning module 160. Upon completion of the cleaning process, the control island 150 transmits control signals driving the second load-unload module 140B to return the plurality of cleaned row bar elements 115D to the feed drive train 180. The plurality of cleaned row bar elements 115D are then translated to the end of the feed drive train 180 where a finished product receptacle 170 (for example, an exit cassette or a magazine) receives elements 115D at a second end 182 of the feed drive train 180. The finished product receptacle 170 is then automatically or manually removed.

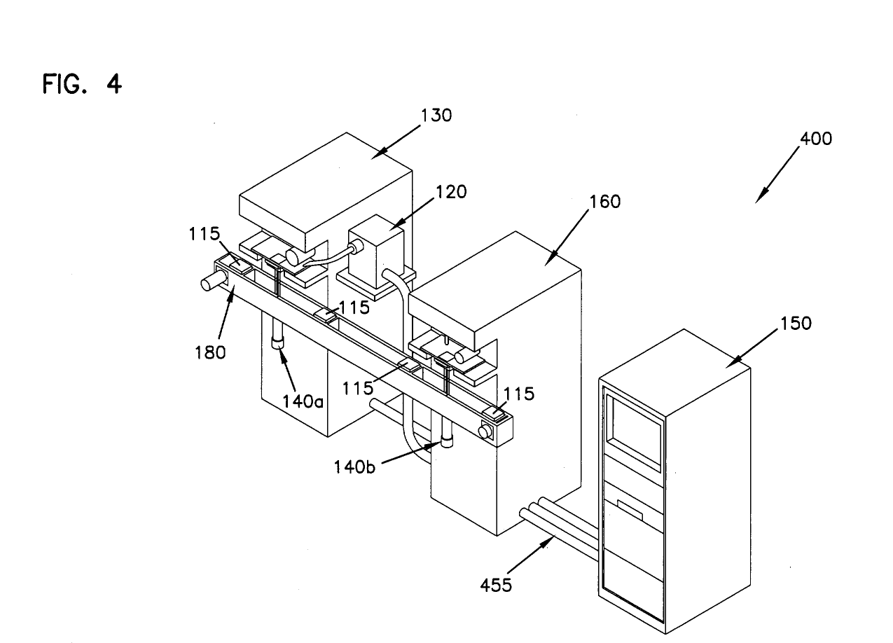

FIG. 4 illustrates a modular dicing system 400 that is a detailed version of the system 100 shown in FIG. 3. The modular dice system 400 may include a dicing station that includes a vision module 120 coupled to a cutting module 130 by a monitoring signal transmission channel, a first load-unload module 140A, a second load-unload module 140B, a cleaning module 160, and feed drive train 180. The modular dice system 400 further includes a control module or control island 150. The system 400 may further include a part carrier 115 coupled to the feed drive train, whereby an undiced row bar, a plurality of row bar elements, a plurality of cleaned row bar elements, or sliders, as the case may be at various stages of in the process, are translated through the system 400.

The cutting module 130 includes a cut stage device for dicing an undiced row bar (not shown) into a plurality of row bar elements (not shown). The control island 150 contains power, control software, networking and analysis/database functions, as well as control of consumables such as cut coolant/slurry or cleaning solvents. The control island 150 is operatively and communicatively coupled to the vision module 120, the cutting module 130, the first and second load-unload modules 140A and 140B, the cleaning module 160, and the feed drive train 180. This coupling is implemented by coupling network lines 455 that extend throughout the system. The network lines 455 enable the control island 150 to, for example, control the modules and supply the necessary consumables for the system 400.

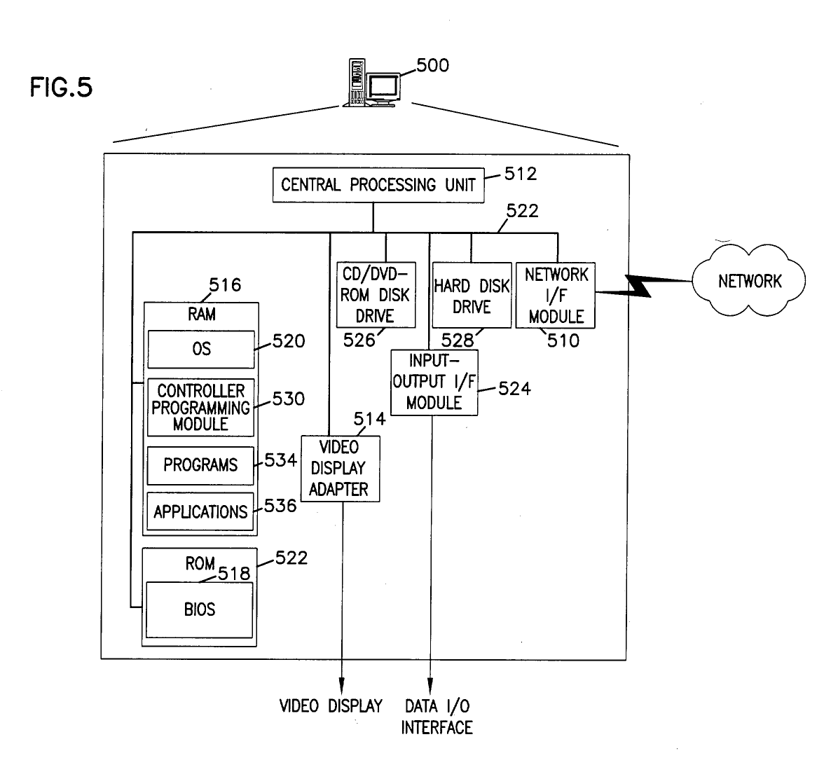

FIG. 5 illustrates an embodiment of computing systems that may be used as part of a control island (such as control islands 1 and 150 discussed above) according to an exemplary embodiment of the present invention. The computing systems may include a master controller processing system 500 that is connected to a WAN/LAN or other communications network via a network interface unit 510. Those of ordinary skill in the art will appreciate that network interface unit 510 includes the necessary circuitry for connecting a processing system to WAN/LAN, and is constructed for use with various communication protocols including the TCP/IP protocol. Typically, network interface unit 510 is a card contained within the processing system 500.

The processing system 500 may also include a processing unit 512, a video display adapter 514, and a mass memory, all connected via bus 522. The mass memory generally includes RAM 516, ROM 522, and one or more permanent mass storage devices, such as a hard disc drive 528, a tape drive (not shown), CDROM/DVD-ROM drive 526, and/or a floppy disc drive (not shown). The mass memory stores an operating system 520 (shown, for example, as part of RAM 516) for controlling the operation of master controller processing system 500. It will be appreciated that operating system 520 may include a general purpose server operating system known to those of ordinary skill in the art, such as UNIX, LINUX™, MAC OS®, or Microsoft WINDOWS NT®. A basic input/output system (“BIOS”) 518 (shown, for example, as part of ROM 522) may also be provided for controlling the low-level operation of master controller processing system 500.

The mass memory as described above illustrates may include another type of computer-readable media, namely computer storage media. Computer storage media may include volatile and nonvolatile, removable and non-removable media implemented using any method or technology for storage of information (such as computer readable instructions, data structures, program modules or other data). Examples of computer storage media include RAM, ROM, EEPROM, flash memory or other memory technology, CD-ROM, digital versatile discs (DVD) or other optical storage, magnetic cassettes, magnetic tape, magnetic disc storage or other magnetic storage devices, or any other medium which can be used to store the desired information and which can be accessed by a computing device.

The mass memory may also store program code and data that facilitate a master controller processing and network development. More specifically, the mass memory stores applications including a master controller processing module 530, programs 534, and other applications 536. Processing module 530 includes computer executable instructions that, when executed by master controller processing system 500, perform the logic described above.

The processing system 500 may also include an input/output interface 524 for communicating with external devices, such as a mouse, keyboard, scanner, or other input devices not shown in FIG. 5. Likewise, master controller processing system 500 may further include additional mass storage facilities such as CD-ROM/DVD-ROM drive 526 and hard disc drive 528. Hard disc drive 528 is utilized by master controller processing system 500 to store, among other things, application programs, databases, and program data used by master controller processing module 530. For example, customer databases, product databases, image databases, and relational databases may be stored in hard disc drive 528 and CD-ROM/DVD-ROM drive 526. The operation and implementation of these databases is well known to those skilled in the art.

One skilled in the art may readily recognize that a processing system 500 may possess only a subset of the components described and still remain within the spirit and scope of the present invention. For example, in one embodiment, the mass storage devices for the master controller processing system 500 may be eliminated with all of the data storage being provided by solid state memory. Programming modules may be stored in ROM or EEPROM memory for more permanent storage where the programming modules consist of firmware that is loaded or updated infrequently. Similarly, many of the user interface devices such as input devices and display devices may not be required in an embedded processing system.

Each of the modular manufacturing modules discussed above typically do not require a general purpose processing (for example, system 500 shown in FIG. 5) that is used for a control island. Rather, these manufacturing modules use an embedded processing system to support the specialized processing requirements of each particular manufacturing module.

In one embodiment of the present invention, each of the modules discussed above with reference to FIGS. 2-4 include a common embedded computing module. This embedded computing module provides programmatic control over the particular manufacturing devices (i.e. vision module 120, first and second body/unload module 140, cleaning module 160 and feed drive train 180). The control island 250 (see FIG. 2) communicates with each embedded computing module 601 in each manufacturing device in order to command the operation of the individual modular manufacturing modules.

An exemplary system embedded computing module 601 includes a processing unit 611 coupled to a RAM 614 and a non-volatile memory 615, a system bus (not shown) that couples various system components to each other, a network interface 612, and a module control interface module 613. The computing module 601 may receive signals 602 from the control island via the communication network. Likewise, the computing module 601 may control connection of the modular manufacturing module 613 via connection 603

A number of program modules may be stored on the RAM 614 or non-volatile memory 615. Generally, program modules include routines, programs, objects, components, data structures, etc. that perform particular tasks or implement particular abstract data types. Typically, the functionality of the program modules may be combined or distributed as desired in various embodiments. One exemplary function of a program module or an application module according to one embodiment of the current invention includes performing a self-test or safety monitoring functions. It can be appreciated by one skilled in the art that there are a multitude of different, more or less complex configurations of a general purpose computing system that may have embedded within it a computing system similar to computing module 601, such that it need not be shown or discussed in further detail.

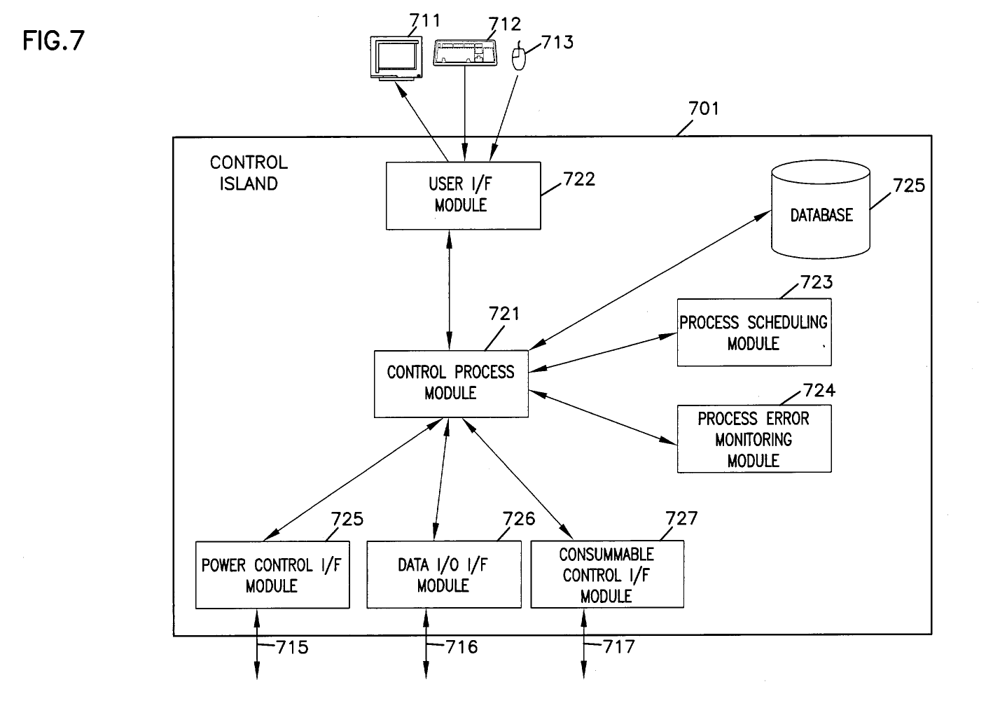

FIG. 7 illustrates a set of processing modules used as part of a control island 701 according to an example embodiment of the present invention. The control island includes a user I/F (i.e., interface) module 722, a control process module 721, power control I/F module 725, data I/O I/F module 726, a consumable control I/F module 727, a process error monitoring module 724, and a process scheduling module 723. The control island 701 may further include a database 725. A user interacts with the control island through a monitor 711 and a keyboard 712 that are coupled to the user I/F module 722. The control island communicates and receives power control, data I/O and consumable control signals from the various dicing stations over transmission lines 715, 716 and 717, respectively.

The control process module 721 is coupled to and communicates with the process error monitoring module 724, which senses when internal process errors occur and communicates such back to the control process module 721. The control process module 721 is also coupled to and communicates with the process scheduling module 723, which works with the control process module 721 to properly schedule processing of the plurality of commands and communications between the control island 701 and other modules. The database 725 relates to operation and components for the various modular manufacturing modules and is maintained within the control island 701. The database 725 is coupled to the control process module 721, and stores the data that the control process module 721 needs to properly operate.

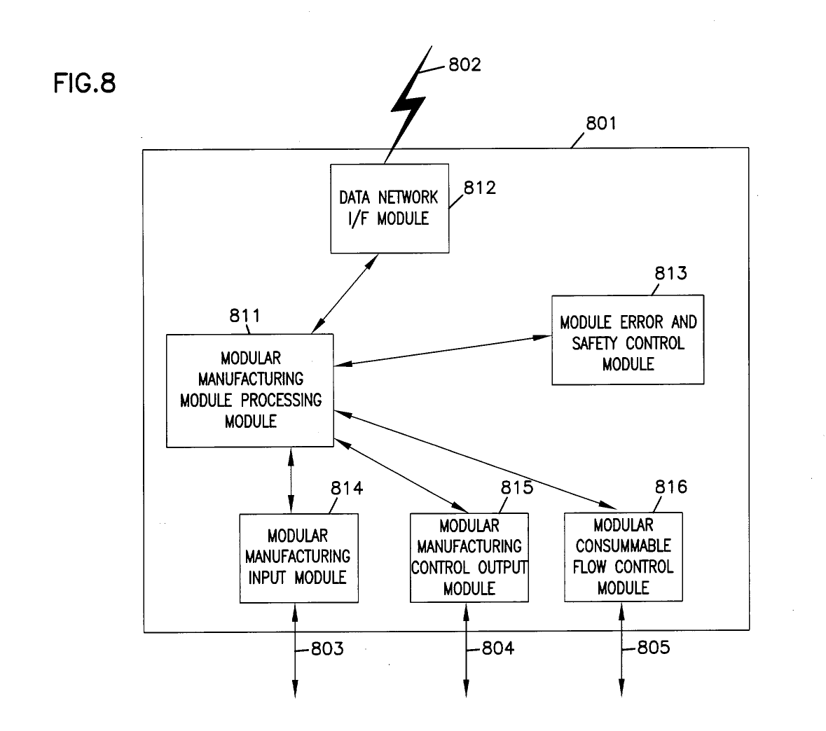

FIG. 8 represents an example set of processing modules used as part of a modular manufacturing processing module 801. The processing module 801 may include a data network I/F module 812, a module error and safety control module 813, a module consumable flow control module 816, a module manufacturing control output module 815, and a modular manufacturing input module 814, each communicatively coupled to a modular manufacturing module processing module 811. The modular manufacturing module processing module 811 processes the data from each module and transmits appropriate control signals to each module to ensure proper overall manufacturing performance.

The data network I/F module 812 receives signals 802 from the control island via the communication network. The module 812 then sends the processed signal to the modular manufacturing module processing module 811 for further processing. The module error and safety control module 813 monitors the system for errors during processing. The control module 813 is also responsible for monitoring the dicing system for unsafe scenarios and alerting the modular manufacturing module processing module 811 if such unsafe scenarios arises. In turn, the processing module 811 would inform the control island of such conditions.

The modular manufacturing input module 814, receives input from a dicing system (not shown) via a data line 803, and routes the signal to the modular manufacturing module processing module 811. The modular manufacturing control output module 815 receives control signals from the modular manufacturing module processing module 811, and after processing routes the signal into the dicing system (not shown) via data line 804. The module consumable flow control module 816 receives control signals from the modular manufacturing module processing module 811 related to the release of system consumables, and routes the control signal via data line 805 to the dicing system (not shown).

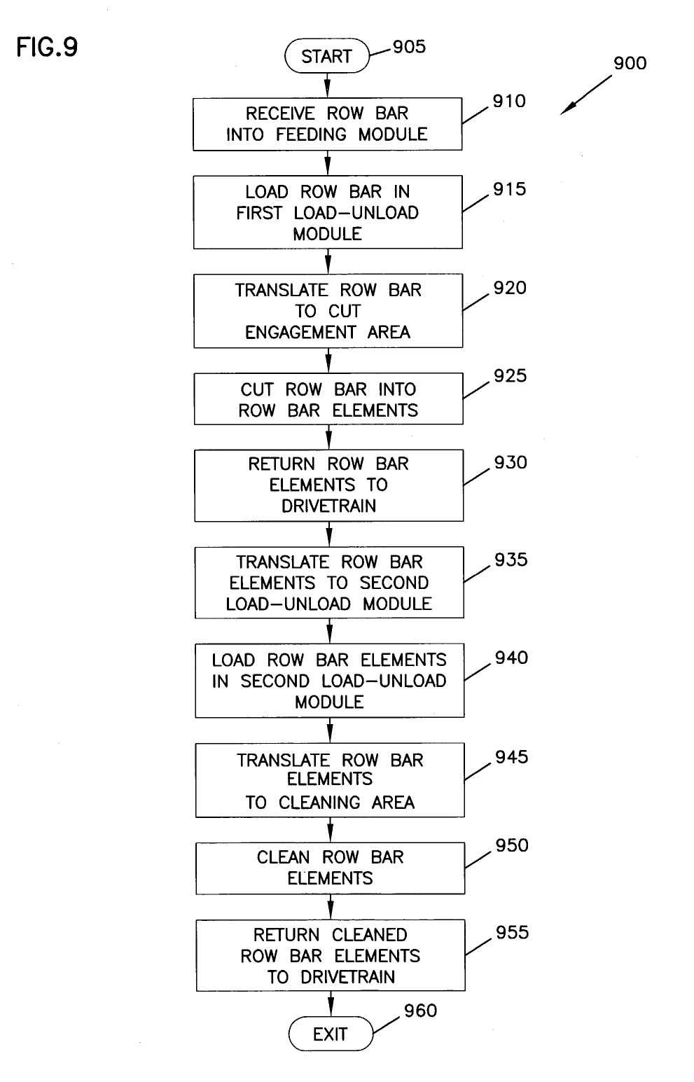

FIG. 9 illustrates an operational flowchart 900 corresponding to a modular dicing system according to one embodiment of the present invention. The operational process begins when the system is powered “on” in a Start stage (905). An operator of the system may then place a magazine of row bars at the entrance end of the dicing station and a row bar is engaged by a carrier and received by the feeding module (910). The carrier carrying the row bar is coupled to the feed drive train and is transferred by the drive train to the load-unload module where the row bar and carrier are loaded into the load-unload module (915). The row bar is then vertically translated to a cut engagement area (920), which is disposed adjacent the cut stage device. The cut stage device then begins slicing the row bar into a plurality of smaller row bar elements (925). The first load-unload module then lowers the carrier, which is carrying the plurality of row bar elements, to the feed drive train (930). Thereafter, the carrier continues to translate the row bar elements to the second load-unload module (935).

The carrier and row bar elements are then loaded into the second load-unload module (940), and the row bar elements are vertically translated to a cleaning stage area (945), which is disposed adjacent a cleaning stage device. The plurality of row bar elements are then cleaned and processed by the cleaning device (950). After being cleaned, the plurality of cleaned row bar elements are lowered by the second load-unload module lowers the carrier to the feed drive train (955). Thereafter, the carrier continues to translate the cleaned row bar elements to the Exit stage (960), wherein the carrier places the elements in an exit receptacle.

The embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

While the above embodiments of the present invention describe a modular dice system for slider bar parting, one skilled in the art will recognize that the processing systems discussed above are merely example embodiments of the present invention. As long as modular manufacturing processing and fabrication is used, the present invention may be configured for use in other data processing systems. It is to be understood that other embodiments may be utilized and operational changes may be made without departing from the scope of the present invention as recited in the attached claims.

As such, the foregoing description of the exemplary embodiments of the invention has been presented for the purposes of illustration and description. They are not intended to be exhaustive or to limit the invention to the precise forms disclosed. Many modifications and variations are possible in light of the above teaching. It is intended that the scope of the invention be limited not with this detailed description, but rather by the claims appended hereto. Since many embodiments of the invention can be made without departing from the spirit and scope of the invention, the invention resides in the claims hereinafter appended.

We claim:

1. A dice system configured to manufacture disc drive heads from a substrate, comprising:
a first dicing station, the station including a plurality of processing modules; and
a control module separate and distinct from the first dicing station, the control module being adapted and configured to control functions of the first dicing station modules and capable of being positioned at a remote location from the first dicing station.

2. The system of claim 1, wherein the first dicing station includes a cutting module, the cutting module including a cutting device configured to cut the substrate into a plurality of elements.

3. The system of claim 2, wherein the first dicing station further includes a cleaning module configured to clean the plurality of elements.

4. The system of claim 3, wherein the first dicing station further includes a carrier device configured to carry the substrate, and a drive train configured to transport the substrate and carrier through the first dicing station.

5. The system of claim 1, wherein the first dicing station includes a feeding module configured to receive an uncut substrate, the uncut substrate comprising a row bar.

6. The system of claim 4, wherein the first dicing station includes a first load-unload module, the first load-unload module configured to move the substrate from the drive train to a position adjacent the cutting device of the cutting module.

7. The system of claim 6, wherein the first dicing station further includes a second load-unload module, and the cleaning module includes a cleaning device, the second load-unload module configured to move the substrate from the drive train to the a position adjacent the cleaning device.

8. The system of claim 6, wherein the cutting device is a wheel saw.

9. The system of claim 2, wherein the first dicing station further includes a vision module, the vision module configured to determine a position of the substrate relative to the cutting device.

10. The system of claim 9, wherein the control module processes signals from the vision module and responsively transmits a control signal to the cutting module to guide the cutting device.

11. The system of claim 9, wherein the vision module includes fiber optics to determine the position of the substrate relative to the cutting device.

12. The system of claim 1, wherein the control module includes a power source, system control, data processing and data storage to control functions of the first dicing station.

13. The system of claim 12, wherein the control module further includes consumables maintenance controls for the first dicing station, the consumable including coolants and cleaning solvents.

14. The system of claim 1, wherein each of the plurality of processing modules are substantially automated.

15. The system of claim 1, wherein the control module comprises a microprocessor and memory, wherein the memory stores a set of software instructions for execution by the microprocessor.

16. The system of claim 1, further comprising one or more dicing stations in addition to the first dicing station, each of the two or more dicing stations including a plurality of processing modules.

17. The system of claim 3, wherein the cutting and cleaning modules are separate and distinct modules from each other.

18. A method of manufacturing a disc drive head from a substrate with a dice system, the system comprising a first dicing station, the first dicing station including a plurality of processing modules and a drive train, the system further comprising a control module separate and distinct from the first dicing station, the method comprising the steps of:
moving the substrate from one processing module to another processing module of the dicing station with the drive train; and
controlling functions of the plurality of processing modules of the first dicing station with the control module to form a disc drive head from the substrate.

19. The method of claim 18, wherein the first dicing station includes a cutting module having a cutting device, the method further comprising the step of cutting the substrate into a plurality of cut elements with the cutting device.

20. The method of claim 19, wherein the first dicing station includes a cleaning module having a cleaning structure, the method further comprising the step of cleaning the cut elements.

21. The method of claim 19, wherein the first dicing station includes a first load-unload module, the method further comprising the step of moving the substrate from the drive train to a position adjacent the cutting device with the first load-unload module.

22. The method of claim 20, wherein the first dicing station includes a second load-unload module, the method further comprising the step of moving the cut elements of the substrate from the drive train to a position adjacent the cleaning structure.

23. The method of claim 19, wherein the first dicing station further includes a vision module, the method further comprising the step of determining a relative position between the substrate and the cutting device using the vision module.

24. The method of claim 18, wherein the first dicing station includes a loading module, the method further comprising the step of loading the substrate into the dicing station with the loading module.

25. The method of claim 18, wherein the system further comprises one or more dicing stations in addition to the first dicing station, each of the one or more additional dicing station including a plurality of processing modules, and the controlling step includes controlling the plurality of processing modules of each of the dicing stations with the control module.

26. The method of claim 18, wherein the control module includes consumables controls, the method comprising the supplying consumables to the first dice station using the consumables controls.

27. The method of claim 26, wherein the supplying consumables step includes supplying cleaning solvents and coolants to the first dice station.

28. The method of claim 18, further comprising the step of automating functions of the plurality of processing modules.

29. A modular dicing system, comprising:
at least one modular dicing station, the at least one dicing station including a drive train, first and second load-unload modules, a cutting module, and a cleaning module, the cutting and cleaning modules being operatively coupled to the feed drive train and the first and second load-unload modules; and
control means for controlling the at least one modular dicing station, the control means being separate and distinct from the at least one modular dicing station, the control means being capable of being positioned at a remote location from the first dicing station.

30. The system of claim 29, wherein the system is adapted and configured to form a disc drive head from a row bar, and the cutting module is configured to cut the row bar into a plurality of row bar elements.

31. The system of claim 30, wherein the at least one modular dicing station includes a vision module operatively coupled to the cutting module, and the vision module is configured to monitor the cutting module and the row bar.

32. The system of claim 29, wherein the control means includes a control and communication module operatively and communicatively coupled to the plurality of substantially automated modules.

33. The system of claim 32, wherein the control and communication module includes a microprocessor and memory, the memory configured to store a set of software instructions for the microprocessor to access and execute.

34. The system of claim 32, wherein the control means is communicatively coupled to a communication interface module via an Internet connection.

35. The system of claim 29, wherein the control means provides power, system control, data processing, networking and database functionality to the at least one modular dicing station.

36. The system of claim 29, wherein the control means controls a plurality of modular dicing stations.
